(19) United States
(12) Patent Application Publication
(10) Pub. No.: US 2013/0157670 A1
(43) Pub. Date: Jun. 20, 2013

(54) Device-To-Device Discovery In Cellular Communications

(71) Applicants: Timo K. Koskela, Oulu (FI); Sami-Jukka Hakola, Kempele (FI); Samuli Turtinen, Ii (FI)

(72) Inventors: Timo K. Koskela, Oulu (FI); Sami-Jukka Hakola, Kempele (FI); Samuli Turtinen, Ii (FI)

(73) Assignee: Renesas Mobile Corporation

(21) Appl. No.: 13/334,533

(22) Filed: Dec. 22, 2011

(30) Foreign Application Priority Data
Dec. 19, 2011 (GB) 1121823.7

(51) Int. Cl. H04W 72/04

(52) U.S. Cl. 455/450

(57) ABSTRACT

The specification and drawings present a new method, apparatus and software related product (e.g., a computer readable memory) for implementing a cellular oriented mechanism such as Random Access (RA) mechanism to support device-to-device (D2D) discovery procedure and D2D connection setup for a direct D2D communication of cellular devices such as UEs, e.g., in LTE wireless systems. The network can provide D2D uplink resource(s) to UEs for setting the D2D communication based on a RACH preamble (e.g., mapped according to a predefined procedure from the discovery signal) received by the network from the UE.

### RELATED APPLICATIONS

This application claims priority to UK Patent Application Number GB1121823.7 filed on Dec. 19, 2011.

### TECHNICAL FIELD

The exemplary and non-limiting embodiments of this invention relate generally to wireless communications and more specifically to implementing a cellular oriented mechanism for a direct device-to-device communication of cellular devices, e.g., in LTE wireless systems.

### BACKGROUND ART

The following abbreviations that may be found in the specification and/or the drawing figures are defined as follows:

CDM Code Division Multiplexing

C-RNTI Cell Radio Network Temporary Identifier

D2D Device-to-Device

DL Downlink

E-UTRA Evolved Universal Terrestrial Radio Access

eNB, eNodeB Evolved Node B/Base Station in an E-UTRAN System

E-UTRAN Evolved UTRAN (LTE)

FDM Frequency Division Multiplexing

L2 Layer 2 (Data Link Layer)

L3 Layer 3 (Network Layer)

ID Identification

LTE Long Term Evolution

LTE-A Long Term Evolution Advanced

M2M Machine-to-Machine

PRACH Physical Random Access Channel

PRB Physical Resource Block

PRACH Physical Random Access Channel

PRB Physical Resource Block

PUCCH Physical Uplink Control Channel

PUSCH Physical Uplink Shared Channel

RACH Random Access Channel

RA Random Access

RAR Random Access Response

RA-RNTI Random Access Radio Network Temporary Identifier

RNTI Radio Network Temporary Identifier

Rx Reception, Receiver

TA Timing Advance

TD Timing Delay

TDM Time Division Multiplexing

Tx Transmission, Transmitter

TTI Transmission Time Interval

UE User Equipment

UP Uplink

UTRAN Universal Terrestrial Radio Access Network

Device-to-device (D2D) communication may enable new service opportunities and reduce the eNB load for short range data intensive peer-to-peer communications. Qualcomm has proposed a study item for the D2D in 3GPP TSG-RAN #52 plenary, 31 May-3 Jun. 2011, e.g., see Tdoc-RP-110706, “On the need for a 3GPP study on LTE device-to-device discovery and communication”, Qualcomm Incorporated, 3GPP TSG-RAN #52, Bratislava Slovakia May 31-Jun. 3, 2011; Tdoc-RP-110707, “Study on LTE Device to Device Discovery and Communication—Radio Aspects, “Qualcomm Incorporated, 3GPP TSG-RAN #52, Bratislava Slovakia May 31-Jun. 3, 2011; Tdoc-RP-110708, “Study on LTE Device to Device Discovery and Communication—Service and System Aspects,” Qualcomm Incorporated, 3GPP TSG-RAN #52, Bratislava Slovakia May 31-Jun. 3, 2011.

One of the main targets is to evolve the LTE platform in order to intercept the demand of proximity-based applications by studying enhancements to the LTE radio layers that allow devices to discover each other directly over the air, and potentially communicate directly, when this makes sense from a system management point of view, upon appropriate network supervision.

The 3GPP TSG-RAN #52 document Tdoc-RP-110706, cited above, states as follows: “This radio-based discovery process needs also to be coupled with a system architecture and a security architecture that allow the 3GPP operators to retain control of the device behavior, for example who can emit discovery signals, when and where, what information do they carry, and what devices should do once they discover each other.”

In general the device-to-device discovery can occur on a licensed or unlicensed band. In both cases the discovery can be autonomous, semi-autonomous, network controlled or between these options.

D2D discovery signaling between devices to provide a connection setup between the devices is one of the key mechanisms to facilitate the network controlled D2D operation. In the network controlled D2D operation the network plays an integral role in the link setup by assigning resources for the communication as well as for the D2D discovery signaling. It can be also assumed that in certain cases the D2D discovery transmission is triggered by a higher layer action (e.g., by an application) and an intended recipient for the discovery signal is already known. On the other hand the discovery transmission can be used to connect previously unknown devices in the proximity.

In general, the challenge for setting D2D wireless communications is to minimize the signaling between D2D devices as well as the signaling between network and the said D2D devices in the connection setup and discovery phase.

### SUMMARY

According to a first aspect of the invention, a method comprises: receiving by a second device a discovery signal from a first device for establishing a device-to-device communication, the discovery signal comprising a discovery signal identification; mapping by the second device the received discovery signal identification or an identification of a discovery signal resource to a random access preamble within a plurality of random access channel preambles; and transmitting by the second device the mapped random access channel preamble in reply to the discovery signal.

According to a second aspect of the invention, a method comprises: receiving by a network element from a first or second device a signal comprising a device-to-device random access channel preamble; and transmitting by the network element a random access response signal comprising an allocation of at least one uplink resource for the device-to-device communications, the allocation of the at least one uplink resource is based on the random access channel preamble.

According to a third aspect of the invention, an apparatus comprises: at least one processor and a memory storing a set of computer instructions, in which the processor and the memory storing the computer instructions are configured to cause the apparatus to: receive by a second device a discovery signal from a first device for establishing a device-to-device communication, the discovery signal comprising a discovery signal identification; map by the second device the received discovery signal identification or an identification of a discovery signal resource to a random access preamble within a plurality of random access channel preambles; and transmit by the second device the mapped random access channel preamble in reply to the discovery signal.

According to a fourth aspect of the invention, an apparatus comprises: at least one processor and a memory storing a set of computer instructions, in which the processor and the memory storing the computer instructions are configured to cause the apparatus to:

receive from a first or second device a signal comprising a device-to-device random access channel preamble; and

transmit a random access response signal comprising an allocation of at least one uplink resource for the device-to-device communications, the allocation of the at least one uplink resource is based on the random access channel preamble.

According to a fifth aspect of the invention, a computer readable memory encoded with computer readable instructions recorded thereon comprising: code for receiving by a second device a discovery signal from a first device for establishing a device-to-device communication, the discovery signal comprising a discovery signal identification; code for mapping by the second device the received discovery signal identification or an identification of a discovery signal resource to a random access preamble within a plurality of random access channel preambles; and code for transmitting by the second device the mapped random access channel preamble in reply to the discovery signal.

According to a sixth aspect of the invention, a computer readable memory encoded with computer readable instructions recorded thereon comprising: code for receiving by a network element from a first or second device a signal comprising a device-to-device random access channel preamble; and code for transmitting by the network element a random access response signal comprising an allocation of at least one uplink resource for the device-to-device communications, the allocation of the at least one uplink resource is based on the random access channel preamble.

According to a seventh aspect of the invention, a method comprises: receiving by a second device from a first device a discovery signal comprising a random access channel preambles dedicated to establishing a direct device-to-device communication; receiving by the second device from a network element a random access response signal comprising an allocation of at least one uplink resource; and transmitting by the second device a response discovery signal using the at least uplink resource to the first device.

According to a eighth aspect of the invention, an apparatus comprises: at least one processor and a memory storing a set of computer instructions, in which the processor and the memory storing the computer instructions are configured to cause the apparatus to: receive by a second device from a first device a discovery signal comprising a random access channel preambles dedicated to establishing a direct device-to-device communication; receive by the second device from a network element a random access response signal comprising an allocation of at least one uplink resource; and transmit by the second device a response discovery signal using the at least uplink resource to the first device.

### BRIEF DESCRIPTION OF THE DRAWINGS

For a better understanding of the nature and objects of the present invention, reference is made to the following detailed description taken in conjunction with the following drawings, in which:

FIG. 1 is a schematic diagram showing a wireless system with a group of seven UEs under one cell A and adjacent to another cell B with four UEs, in which exemplary embodiments detailed herein, may be practiced to advantage;

FIGS. 2-3 are flow charts demonstrating implementation of exemplary embodiments of the invention performed by a user equipment;

FIG. 4 is a flow chart demonstrating implementation of exemplary embodiments of the invention performed by a network element (e.g., eNB); and

FIG. 5 is a block diagram of wireless devices for practicing exemplary embodiments of the invention.

### DETAILED DESCRIPTION

A new method, apparatus, and software related product (e.g., a computer readable memory) are presented for implementing a cellular oriented mechanism such as Random Access (RA) mechanism to support device-to-device (D2D) discovery procedure and D2D connection setup for direct D2D communication among cellular devices such as UEs, e.g., in LTE wireless systems.

Random access procedure for cellular applications is known in the art, e.g., see chapter 5.1 in 3GPP TS 36.321, V10.3.0 (2011-09). RACH (random access channel) preambles may be grouped by the network, namely to group A and group B. The preamble groups may be used to indicate ‘1’ bit or ‘0’ bit which in turn indicate the L2/L3 message size that the UE will transmit once the grant is received. Upon transmitting with certain RACH (time-frequency) resources the Random Access Response (RAR) is transmitted with a specific RA-RNTI. The RAR may include the resource allocation for transmitting the L2/L3 message to the eNB, as well as the TA and C-RNTI.

The network may divide RACH preambles into D2D RACH preambles and cellular RACH preambles, and may further determine the division of RACH resources between D2D RACH resources and cellular RACH resources, which can be changed dynamically. This preamble and resource division may be signaled in the system information to user equipments (devices). Also the network may configure certain resources for D2D discovery. The resources may be any time-frequency resources on the selected operation bandwidth, such as licensed band. The devices may be able to monitor the discovery resources and detect the ID of the discovery attempt.

In one embodiment referred to as Method 1, a D2D discovery signal ID may be mapped to a specific D2D RACH preamble according to the following scenario. A D2D discovery signal sent by a device UE-1 may use a radio resource/resources within a set of predefined resources which may be different from the RACH resources. Upon receiving the D2D discovery signal on a certain resource a device UE-2 can map the utilized resource or an ID of the received discovery signal to a specific Random Access preamble (this mapping may be known at the device UE-1 which transmitted the D2D discovery signal). For example, the mapping may be implemented by determining a specific mapping function: f_{mapping}(d2d_discovery_ID)=ra_preamble_ID, where d2d_discovery_ID is the ID of the received discovery signal, and ra_preamble_id is the ID of the determined RACH preamble (or D2D RACH preamble). The derived ID then maps to a specific signature (time/frequency resource) which may define the D2D RACH resource for sending the D2D RACH preamble.

It is noted that in this embodiment a set of RACH preambles from which the mapped D2D RACH preamble is chosen and RACH resources used for these mapped D2D RACH preambles are specific for D2D applications/users and are not intended for cellular applications/users.

After the mapping is completed, the device UE-2 which received the D2D discovery signal may transmit a signal comprising the derived ra_preamble_id on the defined D2D RACH resource (as a D2D RACH preamble signal), which is received by the wireless network (e.g., by the eNB). The device UE-1 may or may not receive the D2D RACH preamble signal from the UE-2.

Both devices UE-1 and UE-2 know the RAR message time window when it should arrive and the RA-RNTI. It may require a time constraint (or a resource constraint) between the discovery signal and the RACH preamble signal, i.e., that corresponding RACH preamble mapped from the discovery signal should be sent on the RACH resources n TTIs after the discovery signal transmission where n may correspond to the processing time for the discovery signal reception by the UE-2 since there could be multiple parallel discovery signals detected in one discovery signal transmission time interval.

Thus, in response to the D2D RACH preamble signal, the network (e.g., eNB) may send a RAR message which comprises information about UL resources (or D2D resource grant information) for D2D wireless communication between the devices UE-1 and UE-2. Both devices know the RAR message time window when it should arrive, so they both may receive the information about D2D uplink resources from the network and establish the D2D communication utilizing these resources (UL D2D grant) for communicating directly with each other.

The network may assign PUCCH, PRACH, PUSCH (or other) resources for D2D so that the assigned uplink resources may be used directly for the D2D communication. For example, upon receiving the grant, the device UE-2 which transmitted the D2D RA preamble signal may start transmitting at a first possible transmission slot to the device UE-1 which transmitted the discovery signal. The UL grant can be a full size resource allocation or a small allocation to enable D2D devices just to exchange control information. Also, the device UE-2 may use Msg3 (Msg3 signaling is known as a L2/L3 uplink transmission message in a RACH protocol) to indicate being D2D discovery feedback transmitter.

In a further embodiment referred to as a Method 1a, which is a variation of the Method 1, the D2D discovery signal ID is also mapped to a RACH preamble but this RACH preamble and RACH resources for transmitting the preamble signal are common to D2D and cellular users/applications to enable minimal specification change. As in Method 1, the network may be aware of the discovery signals being transmitted and may have the information about corresponding RACH preambles to be used for the D2D discovery feedback. Moreover, according to this embodiment, legacy cellular users may also transmit the same RACH preamble, e.g., for initial access purposes (i.e., in discovery signal). Also as in Method 1 the network may assign UL D2D resources based on the RACH preamble signal via the RAR message as described herein for D2D communications.

In a still further embodiment referred to as a Method 2, the D2D discovery resources may be D2D RACH preambles so that the preamble (in a discovery signal) is transmitted to the network (e.g., eNB) by the D2D device UE-1 and also detected by other D2D devices (e.g., by the device UE-2). In response to the preamble signal, the network (e.g., eNB) may send a RAR message which comprises information about UL resources (or D2D resource grant information) for D2D wireless communication between the D2D devices (similar to the Methods 1 and 1a). The D2D devices which transmitted and detected the preamble then may listen for the RAR message from the network (e.g., from the eNB) and receive the UL D2D resource grant information. Then the received UL D2D grant resource (e.g., using L2/L3 message) may be used in order to transmit a discovery response message by the device/devices received the preamble discovery signal to the device which transmitted the corresponding preamble discovery signal.

It is noted that the embodiments described herein (e.g., Methods 1, 1a and 2) may be used for multiple D2D wireless devices. Also there are many alternatives and various features which may be used to advantage.

In one embodiment, the network (e.g., eNB) may configure two or more groups for the RACH preambles to use for setting D2D communication by the D2D devices as described herein. Then the embedded information in one bit or in a plurality of bits may be detected by the device receiving the D2D discovery signal and interpreted in a predetermined way. For example, 1-bit indication may correspond to 2 preamble groups, 2-bit indication may correspond to 4 preamble groups, 3-bit indication may correspond to 8 preamble groups, etc. The number of the preamble groups may be determined based on the application.

In another embodiment the embedded information in D2D RACH preamble may be used to convey the following information (the listed information is exemplary and non-limiting):

whether the offered service is a D2D service, having internet connectivity, a broadcast service, machine-to-machine service or an advertised service (e.g., the network may configure dynamically via system information the mapping between the D2D RACH preamble and the advertised service);

whether a current operation mode is a cluster mode;

whether a discovery request is a D2D paring request;

an indication to set up a cluster service or a single link D2D communication, etc.

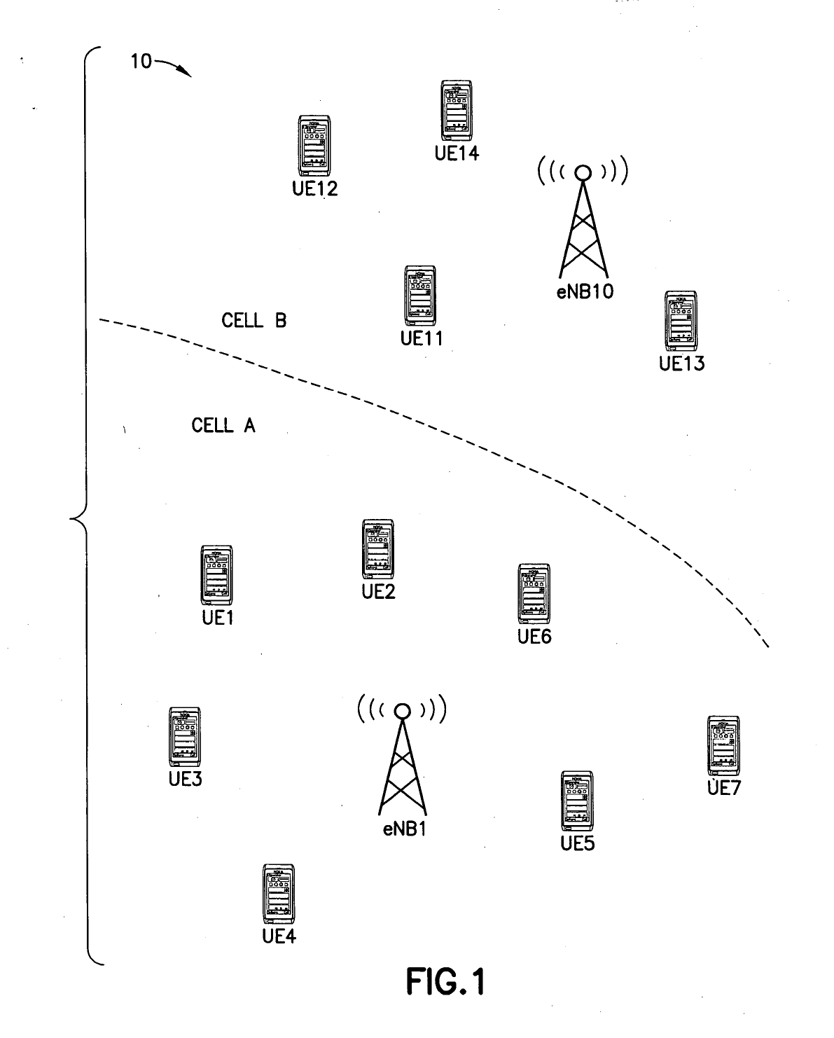

FIG. 1 illustrates an exemplary wireless network 10 in which embodiments of these teachings may be practiced to advantage. Seven UEs, UE1-UE7, are under one cell A with eNB1 and adjacent to another cell B with eNB10 having four UEs UE11-UE14. The discovery signal for D2D communication may be sent by any of the UE1-UE7 or UE11-UE-14 to some other UE/UEs shown in FIG. 1 to establish D2D communication. It is further noted that in LTE wireless systems, FDM, TDM and CDM are all available which may provides the possibility to increase the discovery signal multiplexing capacity.

It is noted that the embodiments described herein involving network participation for setting the D2D communication may be practiced within one cell, e.g., in cell A, where each UE out of the UE1-UE7 may establish D2D communication with another UE out of the UE1-UE7 in the cell A. However, the embodiments may be extended to establishing D2D communication between UEs in different cells (e.g., A and B) if, for example, the eNB1 and eNB10 may provide a coordination for assigning the same uplink resources in response to the D2D RACH preamble signal.

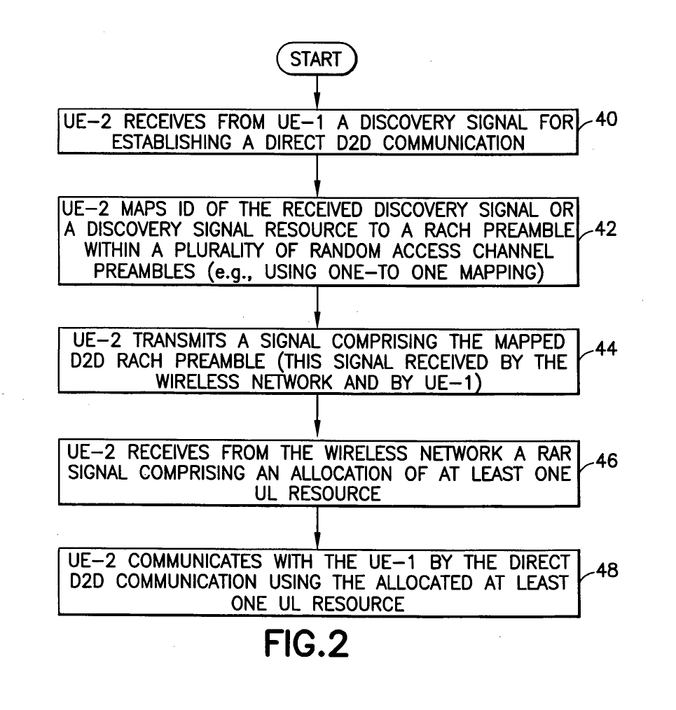

FIG. 2 shows an exemplary flow chart demonstrating D2D discovery performed by a UE receiving the discovery signal as disclosed in Methods 1 and 1a, according to the exemplary embodiments of the invention. It is noted that the order of steps shown in FIG. 2 is not absolutely required, so in principle, the various steps may be performed out of the illustrated order. Also certain steps may be skipped, different steps may be added or substituted, or selected steps or groups of steps may be performed in a separate application.

In a method according to this exemplary embodiment, as shown in FIG. 2, in a first step 40, the UE2 receives from the UE1 a discovery signal for establishing a direct D2D communication (the discovery signal having a resource within a set of predefined resources which e.g., are different from the RACH resources). In a next step 42, the UE2 maps the ID of the received discovery signal or the discovery signal resource to the RACH preamble within a plurality of D2D random access channel preambles (e.g., using one-to-one mapping). Different variations of the mapping are discussed above in reference to Methods 1 and 1a. In a next step 44, the UE2 transmits a signal comprising the mapped D2D RACH preamble. In a next step 46, the UE2 receives from the wireless network a RAR signal comprising an allocation of the at least one UL resource (one or more in general) for the D2D communications. In a next step 48, the UE2 communicates with the UE1 directly using the allocated at least one D2D UL resource. The detailed implementation of steps 40-48 is discussed above in reference to Methods 1 and 1a.

FIG. 3 shows an exemplary flow chart demonstrating D2D discovery performed by a UE receiving the discovery signal as disclosed in Method 2, according to an exemplary embodiment of the invention. It is noted that the order of steps shown in FIG. 3 is not absolutely required, so in principle, the various steps may be performed out of the illustrated order. Also certain steps may be skipped, different steps may be added or substituted, or selected steps or groups of steps may be performed in a separate application.

In a method according to this exemplary embodiment, as shown in FIG. 3, in a first step 60, the UE2 receives from the UE1 a discovery signal comprising a D2D RACH preamble for setting a direct D2D communication (the discovery signal comprising the D2D RACH preamble is received by the wireless network as well). In a next step 62, the UE2 receives from the wireless network (e.g., from the eNB) a RAR signal comprising an allocation of the at least one UL resource for the D2D communication. In a next step 64, the UE2 transmits a response discovery signal using the allocated at least one UL resource to the UE1 to establish D2D connection. Then in a next step 66, the UE2 communicates directly with the UE1 using the allocated at least one D2D UL resource.

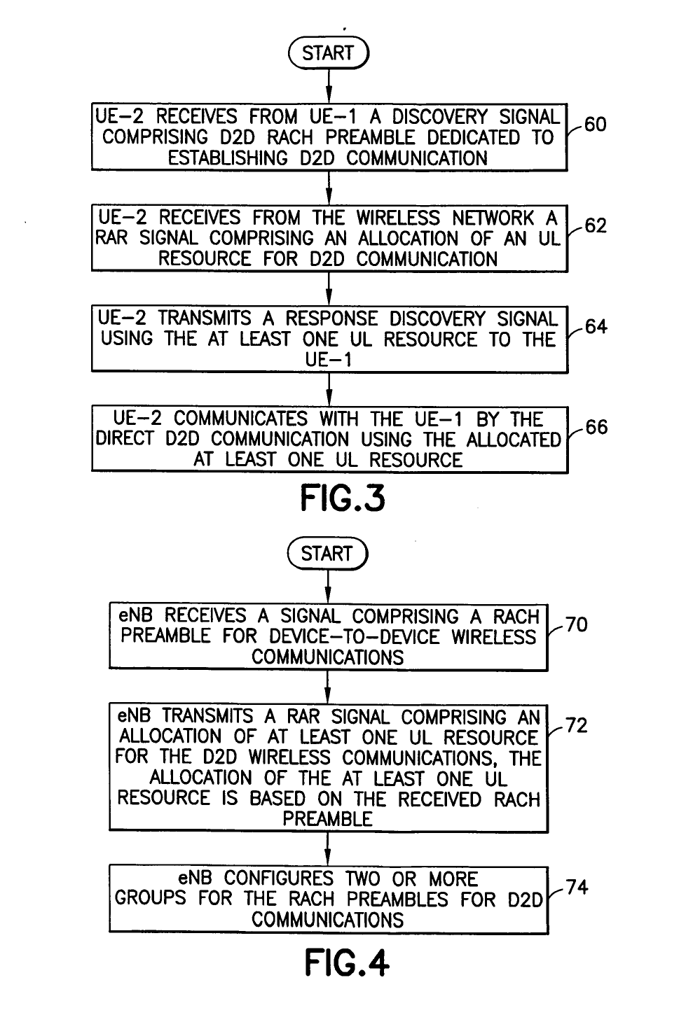

FIG. 4 shows an exemplary flow chart demonstrating performance of the network (e.g., eNB) for facilitating D2D discovery and communication of the mobile devices in the network, according to an exemplary embodiment of the invention which may be practiced to advantage using Methods 1, 1a and 2. It is noted that the order of steps shown in FIG. 4 is not absolutely required, so in principle, the various steps may be performed out of the illustrated order. Also certain steps may be skipped, different steps may be added or substituted, or selected steps or groups of steps may be performed in a separate application.

In a method according to this exemplary embodiment, as shown in FIG. 4, in a first step 70, a network element (e.g., eNB) receives a signal (this signal may be sent in step 44 in FIG. 2 or in step 60 in FIG. 3) comprising a RACH preamble for the device-to-device wireless communications. In a next step 72, the network element transmits a RAR signal comprising an allocation of at least one UL resource for the D2D wireless communications, the allocation of the at least one UL resource is based on the received RACH preamble. In a next step 74, the network element configures two or more groups for the RACH preambles for D2D communication, as explained herein.

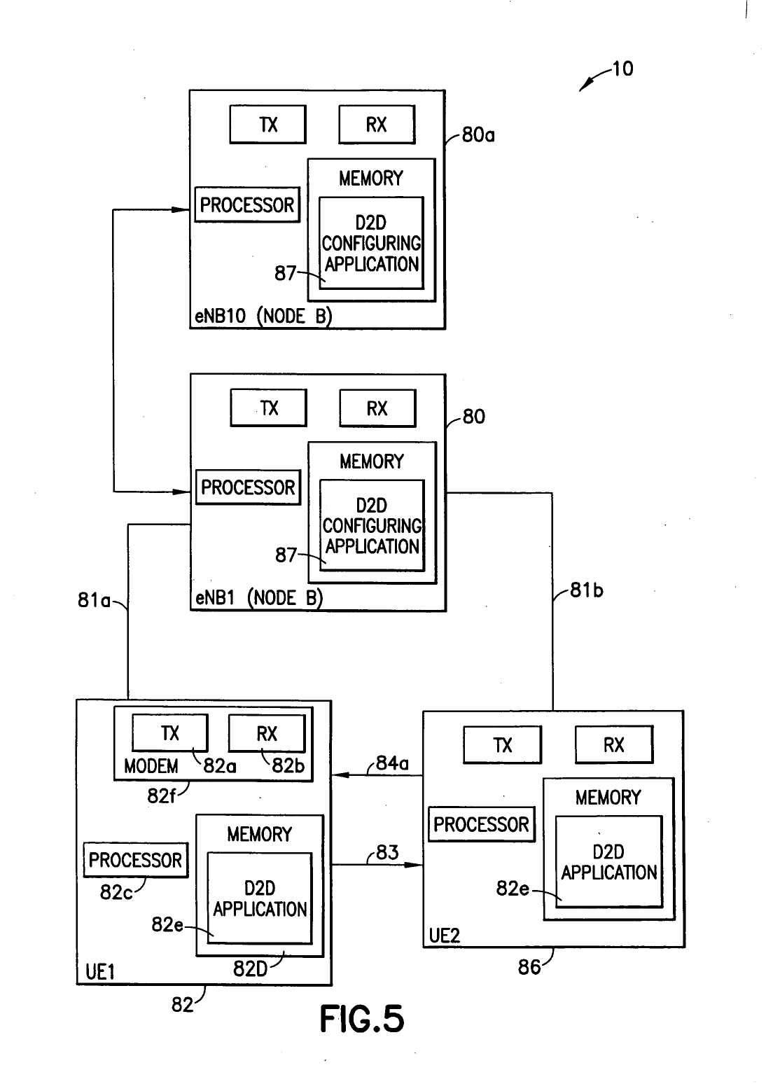

FIG. 5 shows an example of a block diagram demonstrating LTE devices including an eNB1 80 and eNB10 80a, UE1 82 and UE2 86. The eNB1 80 and eNB 10 80a comprise a wireless network 10. FIG. 5 is a simplified block diagram of various electronic devices and apparatus that are suitable for use in practicing the exemplary embodiments of this invention, e.g., in reference to FIGS. 1-4, and a specific manner in which components of an electronic device are configured to cause that electronic device to operate. Each of the UEs 82 and 86 may be implemented as a mobile phone, a wireless communication device, a camera phone, a portable wireless device and the like.

The UE1 82 (the same may be applied to UE2 86) may comprise, e.g., at least one transmitter 82a at least one receiver 82b, at least one processor 82c at least one memory 82d and a D2D application module 82e. The transmitter 82a and the receiver 82b and corresponding antennas (not shown in FIG. 5) may be configured to provide wireless D2D communications with the UE2 86 (and others not shown in FIG. 5) and with eNB1 80, respectively, according to the embodiment of the invention. The transmitter 82a and the receiver 82b may be generally means for transmitting/receiving and may be implemented as a transceiver, or a structural equivalence (equivalent structure) thereof. It is further noted that the same requirements and considerations are applied to transmitters and receivers of the devices 86, 80a and 80a.

Furthermore, the UE1 82 may further comprise communicating means such as a modem 82f, e.g., built on an RF front end chip of the UE 82, which also carries the TX 82a and RX 82b for bidirectional wireless communications via data/control wireless links 81a, 83, 84a, for sending/receiving discovery signal and communicating with the eNB1 80. The same concept is applicable to other devices 80, 80a and 86 shown in FIG. 5.

Various embodiments of the at least one memory 82d (e.g., computer readable memory) may include any data storage technology type which is suitable to the local technical environment, including but not limited to semiconductor based memory devices, magnetic memory devices and systems, optical memory devices and systems, fixed memory, removable memory, disc memory, flash memory, DRAM, SRAM, EEPROM and the like. Various embodiments of the processor 82c include but are not limited to general purpose computers, special purpose computers, microprocessors, digital signal processors (DSPs) and multi-core processors. Similar embodiments are applicable to memories and processors in other devices 86, 80a and 80a shown in FIG. 5.

The D2D application module 82e (in UE1 82 and/or UE2 86) may provide various instructions for performing steps 40-48 in FIG. 2 and/or steps 60-66 in FIG. 3. The module 82e may be implemented as an application computer program stored in the memory 82d, but in general it may be implemented as a software, a firmware and/or a hardware module or a combination thereof. In particular, in the case of software or firmware, one embodiment may be implemented using a software related product such as a computer readable memory (e.g., non-transitory computer readable memory), computer readable medium or a computer readable storage structure comprising computer readable instructions (e.g., program instructions) using a computer program code (i.e., the software or firmware) thereon to be executed by a computer processor.

Furthermore, the module 82e may be implemented as a separate block or may be combined with any other module/block of the UE 82 or UE 86, or it may be split into several blocks according to their functionality.

The other UEs, such as UE2 86, eNB1 80 and eNB10 80a may have similar components as the UE 82, as shown in FIG. 5, so that the above discussion about components of the UE 82 is fully applied to the components of the UE2 86, eNB1 80 and eNB10 80a. A D2D configuring application module 87 in the devices 80 and 80a, is designed to facilitate performing corresponding functions for establishing D2D communication as described herein and illustrated in FIG. 4 (specifically see steps 70-74 in FIG. 4). The module 87 may be implemented as a software, a firmware and/or a hardware module or a combination thereof. In particular, in the case of software or firmware, one embodiment may be implemented using software related product such as a computer readable memory (e.g., non-transitory computer readable memory), a computer readable medium or a computer readable storage structure comprising computer readable instructions (e.g., program instructions) using a computer program code (i.e., the software or firmware) thereon to be executed by a processor.

Furthermore, the module 87 may be implemented as a separate block or may be combined with any other module/block of the device 80 or 80a, or it may be split into several blocks according to their functionality. Moreover, it is noted that all or selected modules of the device 82, 86, 80 or 80a may be implemented using an integrated circuit (e.g., using an application specific integrated circuit, ASIC).

It is noted that various non-limiting embodiments described herein may be used separately, combined or selectively combined for specific applications.

Further, some of the various features of the above non-limiting embodiments may be used to advantage without the corresponding use of other described features. The foregoing description should therefore be considered as merely illustrative of the principles, teachings and exemplary embodiments of this invention, and not in limitation thereof.

It is to be understood that the above-described arrangements are only illustrative of the application of the principles of the present invention. Numerous modifications and alternative arrangements may be devised by those skilled in the art without departing from the scope of the invention, and the appended claims are intended to cover such modifications and arrangements.

1. A method comprising:
receiving by a second device a discovery signal from a first device for establishing a device-to-device communication, the discovery signal comprising a discovery signal identification;
the second device using the received discovery signal identification or an identification of a discovery signal resource to derive a random access preamble within a plurality of random access channel preambles; and
transmitting by the second device the derived random access channel preamble in reply to the discovery signal.

2. The method of claim 1, wherein the random access channel preamble and a resource used for the transmitting the preamble signal is intended to device-to-device applications only or for both the device-to-device applications and for cellular applications.

3. The method of claim 1, wherein a resource for the discovery signal is different than random access channel resources.

4. The method of claim 1, further comprising:
receiving from a network a random access response signal comprising an allocation of at least one uplink resource for the device-to-device communication.

5. The method of claim 4, further comprising:
communicating by the second device directly with the first device using the allocated at least one uplink resource.

6. The method of claim 4, wherein a channel for the at least one uplink resource is a physical uplink control channel, a physical uplink shared channel or a physical random access channel.

7. The method of claim 1, wherein the plurality of random access channel preambles comprise two or more groups.

8. The method of claim 7, further comprising receiving from the network an indication of the two or more groups of the random access channel preambles.

9. The method of claim 1, wherein the discovery signal comprises a legacy random access channel preamble.

10. The method of claim 1, wherein the random access channel preamble is used to convey one or more of:
whether an offered service is a device-to-device service, having interact connectivity, a broadcast service, an advertised service or a machine-to-machine service,
whether a current operation mode is a cluster mode,
whether a discovery request is a device-to-device pairing request, and
an indication to set up a cluster service or a single link device-to-device communication.

11-15. (canceled)

16. An apparatus comprising:
at least one processor and a memory storing a set of computer instructions, in which the processor and the memory storing the computer instructions are configured to cause the apparatus to:
receive by a second device a discovery signal from a first device for establishing a device-to-device communication, the discovery signal comprising a discovery signal identification;
the second device using the received discovery signal identification or an identification of a discovery signal resource to derive a random access preamble within a plurality of random access channel preambles; and
transmit by the second device the derived random access channel preamble in reply to the discovery signal.

17. The apparatus of claim 16, wherein the random access channel preamble and a resource used for the transmitting the preamble signal is intended for device-to-device applications only or for both the device-to-device applications and for cellular applications.

18. The apparatus of claim 16, wherein a resource for the discovery signal is different than random access channel resources.

19. The apparatus of claim 16, wherein the computer instructions are further configured to cause the apparatus to:
receive from a network a random access response signal comprising an allocation of at least one uplink resource for the device-to-device communication; and
communicate directly with the first device using the allocated at least one uplink resource.

20-32. (canceled)
